(19) United States
(12) Patent Application Publication
(10) Pub. No.: US 2022/0122142 A1
(43) Pub. Date: Apr. 21, 2022

(54) CUSTOMIZED PRODUCT AND SERVICE BUNDLER

(71) Applicant: INTERNATIONAL BUSINESS MACHINES CORPORATION, Armonk, NY (US)

(72) Inventors: Junyu Cao, Albany, CA (US); Wei Sun, Tarrytown, NY (US); SHIVARAM SUBRAMANIAN, Frisco, TX (US); Markus Ettl, Yorktown Heights, NY (US)

(21) Appl. No.: 17/070,963

(22) Filed: Oct. 15, 2020

(51) Int. Cl. G06Q 30/06; G06Q 30/02; G06N 20/00

(52) U.S. Cl. CPC G06Q 30/0621; G06Q 30/0283; G06Q 30/0201; G06N 20/00; G06Q 30/0641; G06Q 30/0631; G06Q 30/0623

(57) ABSTRACT

A method, a structure, and a computer system for customized bundles of products and services. The exemplary embodiments may include gathering data corresponding to one or more consumers, one or more products, and one or more services. In addition, exemplary embodiments may further include generating one or more bundles of the one or more products and services corresponding to a consumer of the one or more consumers based on applying one or more models to the gathered data. Moreover, exemplary embodiments may further include determining a price of the one or more bundles, and displaying the one or more bundles to the consumer.

### BACKGROUND

The exemplary embodiments relate generally to marketing and sales of products and services, and more particularly to the customized bundling of products and services.

Bundling is a popular marketing strategy that often consist of offering products and services from different categories at a lesser combined cost than purchasing each product and service individually. For example, a telecommunications company may offer phone, internet, and television service bundles while a travel agency may offer airfare, hotel room, and car rental service bundles. While bundling may be advantageous for both sellers and consumers, identifying combinations of product and service categories to bundle, a concept known as cross-category dependence, as well as identifying combinations of products and services of each category to bundle, a concept known as intra-category substitution, remain challenging problems to solve.

### SUMMARY

The exemplary embodiments disclose a method, a structure, and a computer system for bundle identification and price optimization. The exemplary embodiments may include gathering data corresponding to one or more consumers, one or more products, and one or more services. In addition, exemplary embodiments may further include generating one or more bundles of the one or more products and services corresponding to a consumer of the one or more consumers based on applying one or more models to the gathered data. Moreover, exemplary embodiments may further include determining a price of the one or more bundles, and displaying the one or more bundles to the consumer.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of a bundling system 100, in accordance with the exemplary embodiments.

FIG. 2 depicts an exemplary flowchart 200 illustrating the operations of a bundler 144 of the bundling system 100, in accordance with the exemplary embodiments.

FIG. 3-4 depict an example illustrating the operations of the bundler 144 of the bundling system 100, in accordance with the exemplary embodiments.

FIG. 5 depicts an exemplary block diagram depicting the hardware components of the bundling system 100 of FIG. 1, in accordance with the exemplary embodiments.

FIG. 6 depicts a cloud computing environment, in accordance with the exemplary embodiments.

FIG. 7 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

Bundling is a popular marketing strategy that often consist of offering products and services from different categories at a lesser combined cost than purchasing each product and service individually. For example, a telecommunications company may offer phone, internet, and television service bundles while a travel agency may offer airfare, hotel room, and car rental service bundles. While bundling may be advantageous for both sellers and consumers, identifying combinations of product and service categories to bundle, a concept known as cross- or inter-category dependence, as well as identifying combinations of products and services of each category to bundle, a concept known as intra-category substitution, remain challenging problems to solve.

In fact, using existing data-driven approaches to incorporate both intra-category substitution and cross-category dependence when identifying relevant bundles leads to what is known as the curse of dimensionality. For instance, discrete choice models are commonly used to model customers' behavior or demand when products are substituted. Suppose that with N categories and each category l consisting of nₗ competing products, the number of the bundle choices increases dramatically to a total of Πₗ₌₁^{N}(nₗ+1) choices (which include a no-buy option for each category), resulting in large choice sets that discrete models are unable to cope with.

Similarly, using Gaussian copula, one needs to estimate Σₗ₌₁^{N}nₗ marginal valuation distributions and a covariance matrix of size Σₗ₌₁^{N}nₗ×Σₗ₌₁^{N}nₗ. This brute force implementation of copula inference procedure is computationally intractable.

As a result, existing methods for bundling products and services typically impose restrictive assumptions on product dependence, including 1) assuming there is only one product from each category, i.e., ignore intra-category substitution, and 2) over-simplified product dependence, e.g., products are fully independent or fully correlated.

The invention claimed herein cures the deficiencies of the preceding approaches and curse of dimensionality. The distribution-free method described herein estimates customers' joint preferences that captures intra-category substitution and cross-category dependence. The claimed invention may do so by identifying customer segments that capture heterogeneity in their preferences and implementing a robust formulation for bundle pricing capable of handling noisy data and model misspecification. Moreover, the claimed invention reduces storage requirements by requiring significantly fewer prediction parameters from O(N²) to O(N), where N is the total number of products. Similarly, the claimed invention significantly improves execution speed and reduces runtime memory usage. Thus, the claimed invention facilitates rapid learning and enables real-time calculation of an optimal bundle, i.e., a bundle matching the needs, interests, and budget of a user.

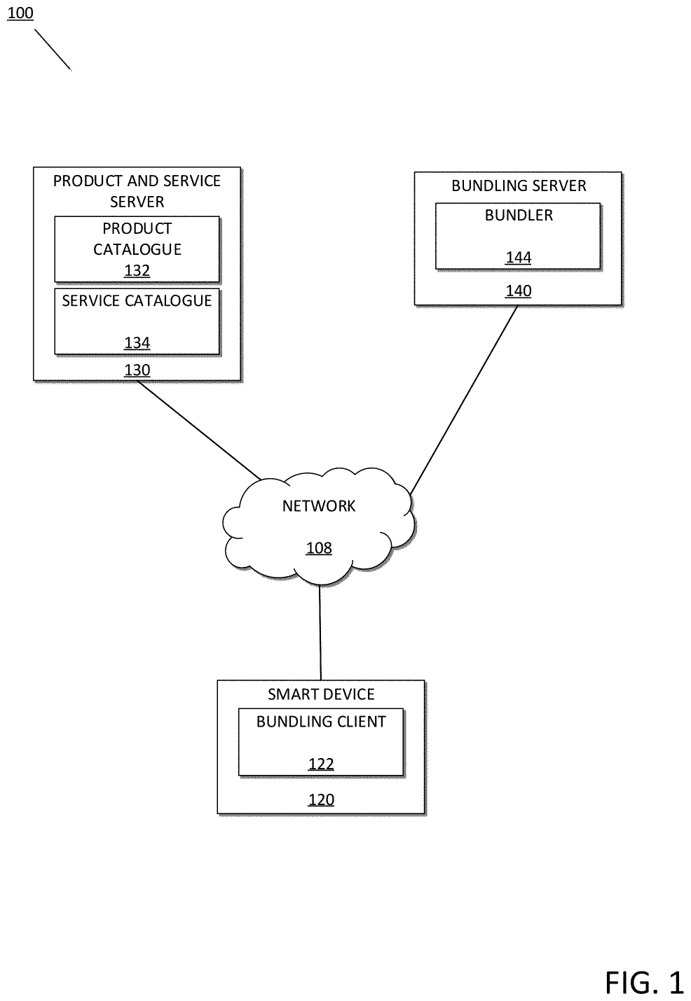

FIG. 1 depicts the bundling system 100, in accordance with exemplary embodiments. According to the exemplary embodiments, the bundling system 100 may include a smart device 120, a product and service server 130, and a bundling server 140, which all may be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted.

In the exemplary embodiments, the network 108 may be a communication channel capable of transferring data between connected devices. In the exemplary embodiments, the network 108 may be the Internet, representing a worldwide collection of networks and gateways to support communications between devices connected to the Internet. Moreover, the network 108 may utilize various types of connections such as wired, wireless, fiber optic, etc. which may be implemented as an intranet network, a local area network (LAN), a wide area network (WAN), or a combination thereof. In further embodiments, the network 108 may be a Bluetooth network, a Wi-Fi network, or a combination thereof. The network 108 may operate in frequencies including 2.4 GHz and 5 GHz internet, near-field communication, Z-Wave, Zigbee, etc. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices.

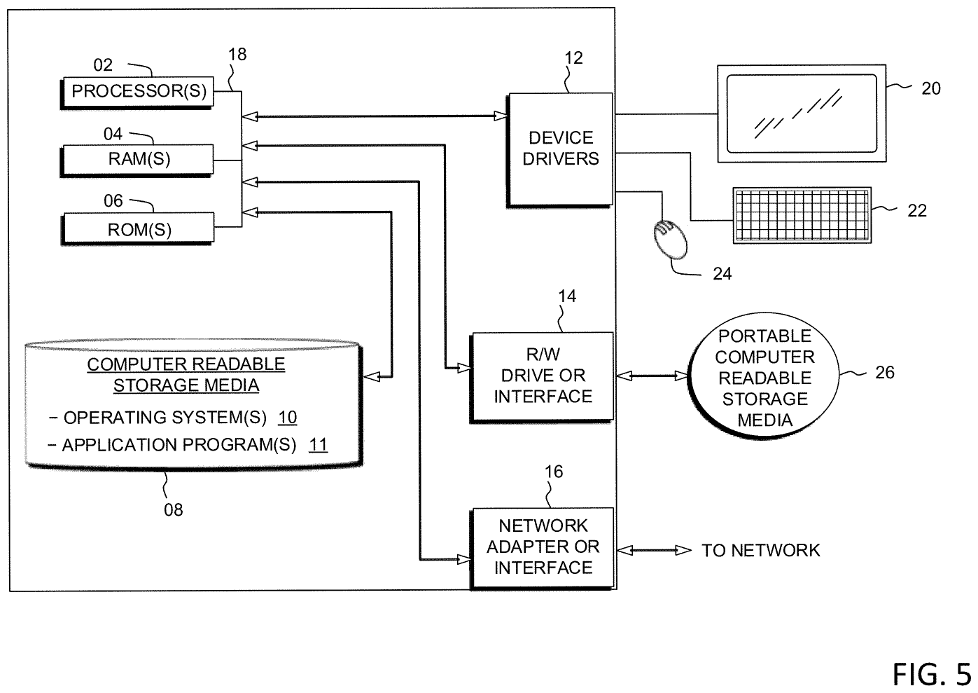

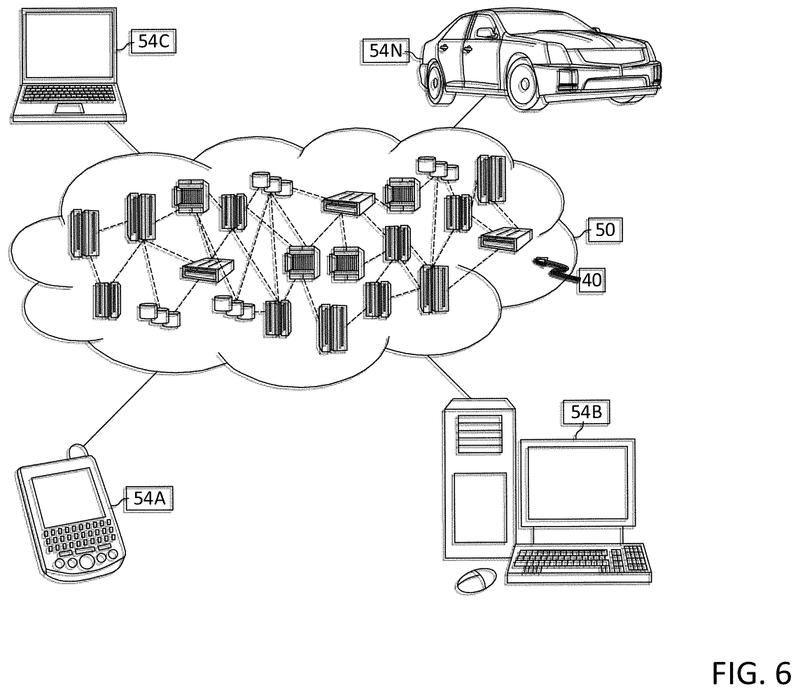

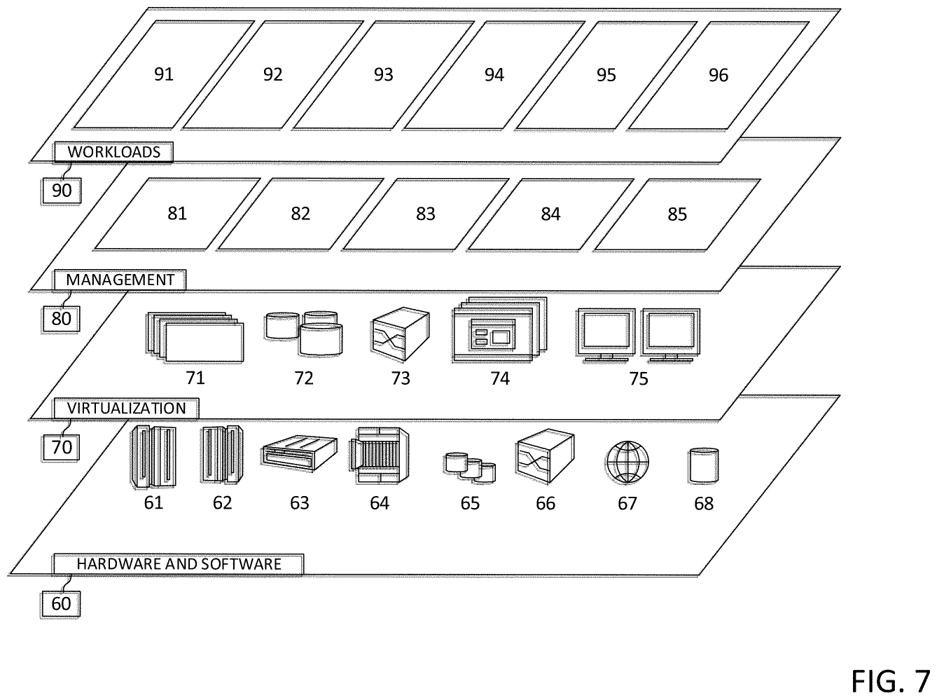

In exemplary embodiments, the smart device 120 includes a bundling client 122, and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of sending and receiving data to and from other computing devices. While the smart device 120 is shown as a single device, in other embodiments, the smart device 120 may be comprised of a cluster or plurality of computing devices, in a modular manner, etc., working together or working independently. The smart device 120 is described in greater detail as a hardware implementation with reference to FIG. 5, as part of a cloud implementation with reference to FIG. 6, and/or as utilizing functional abstraction layers for processing with reference to FIG. 7.

The bundling client 122 may act as a client in a client-server relationship with a server, for example the bundle identification server 140, and may be a software and/or hardware application capable of communicating with and providing a user interface for a user to interact with a server and other computing devices via the network 108. Moreover, in the example embodiment, the bundling client 122 may be capable of transferring data from the smart device 120 to and from other devices via the network 108. In embodiments, the bundling client 122 may utilize various wired and wireless connection protocols for data transmission and exchange, including Bluetooth, 2.4 GHz and 5 GHz internet, near-field communication, Z-Wave, Zigbee, etc. The bundling client 122 is described in greater detail with respect to FIG. 5-7.

In exemplary embodiments, the product and service server 130 includes a product catalogue 132 and a service catalogue 134, and may act as a server in a client-server relationship with the bundling client 122. The product and service server 130 may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of sending and receiving data to and from other computing devices. While the product and service server 130 is shown as a single device, in other embodiments, the product and service server 130 may be comprised of a cluster or plurality of computing devices, in a modular manner, etc., working together or working independently. The product and service server 130 is described in greater detail as a hardware implementation with reference to FIG. 5, as part of a cloud implementation with reference to FIG. 6, and/or as utilizing functional abstraction layers for processing with reference to FIG. 7.

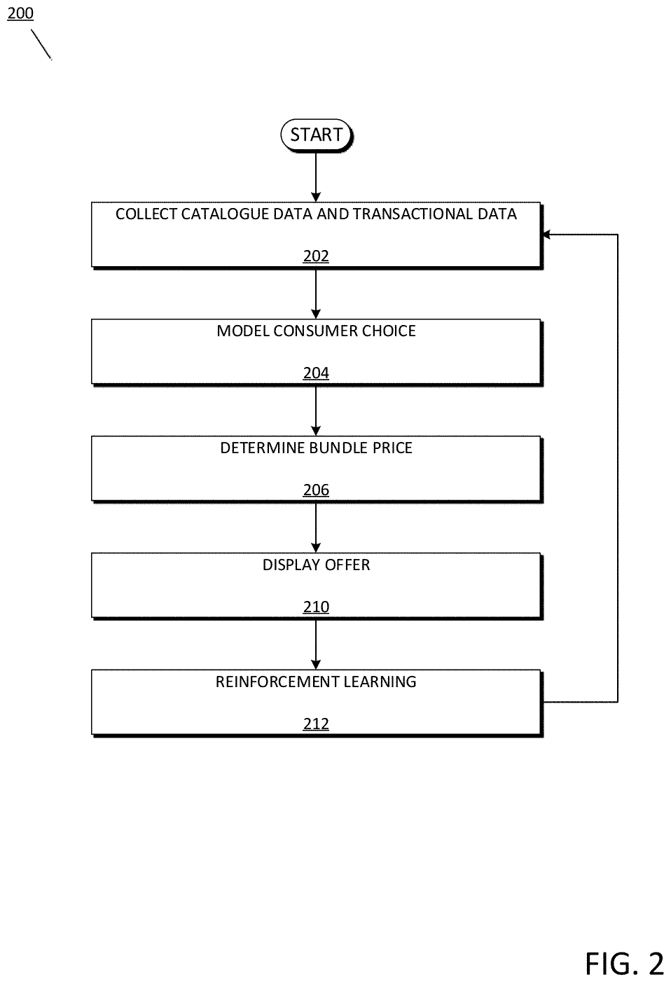

In embodiments, the product catalogue 132 may be a database detailing various products, product prices, product availability, etc. In addition, the product catalogue 132 may detail product sale histories, customer profiles, etc. For example, the product catalogue 132 may include product catalogues, sales and transaction logs, etc. The product catalogue 132 is described in greater detail with reference to FIG. 2-7.

In embodiments, the service catalogue 134 may be a database detailing various services, service prices, service availability, etc. In addition, the product catalogue 132 may detail product sale histories, customer profiles, etc. For example, the service catalogue 134 may include service catalogues, sales and transaction logs, etc. The service catalogue 134 is described in greater detail with reference to FIG. 2-7.

In exemplary embodiments, the bundling server 140 includes a bundler 144, and may act as a server in a client-server relationship with the bundling client 122. The bundling server 140 may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of sending and receiving data to and from other computing devices. While the bundling server 140 is shown as a single device, in other embodiments, the bundling server 140 may be comprised of a cluster or plurality of computing devices, in a modular manner, etc., working together or working independently. The bundling server 140 is described in greater detail as a hardware implementation with reference to FIG. 5, as part of a cloud implementation with reference to FIG. 6, and/or as utilizing functional abstraction layers for processing with reference to FIG. 7.

The bundler 144 may be a software and/or hardware program that may be capable of collecting catalogue and consumer transaction data. The bundler 144 may be further configured to model consumer choice to generate a bundle relevant to a consumer and determine a bundle price. The bundler 144 may additionally display the bundle offer to the consumer and perform reinforcement learning based on the consumer response to the offered bundle. The bundler 144 is described in greater detail with reference to FIG. 2-7.

FIG. 2 depicts an exemplary flowchart 200 illustrating the operations of the bundler 144 of the bundling system 100, in accordance with the exemplary embodiments.

The bundler 144 may collect catalogue data and consumer transactional data (step 202). In embodiments, the customer transactional data may be extracted from respective product and service catalogues 132 and 134 of the product and service server 130, and may include data from transaction logs (TLOG sales), catalogues of products/services, customer relationship management (CRM), etc. Accordingly, the extracted data may include past, current, and future products, services, pricing, categories, and the like. In addition, the extracted data may further include data pertaining to consumers, for example past and present customers, and include demographic information such as gender, age, location, interests, hobbies, etc. In embodiments, the bundler 144 may utilize the collected consumer data and transactional data in order to train the bundling models 142, described in greater detail forthcoming.

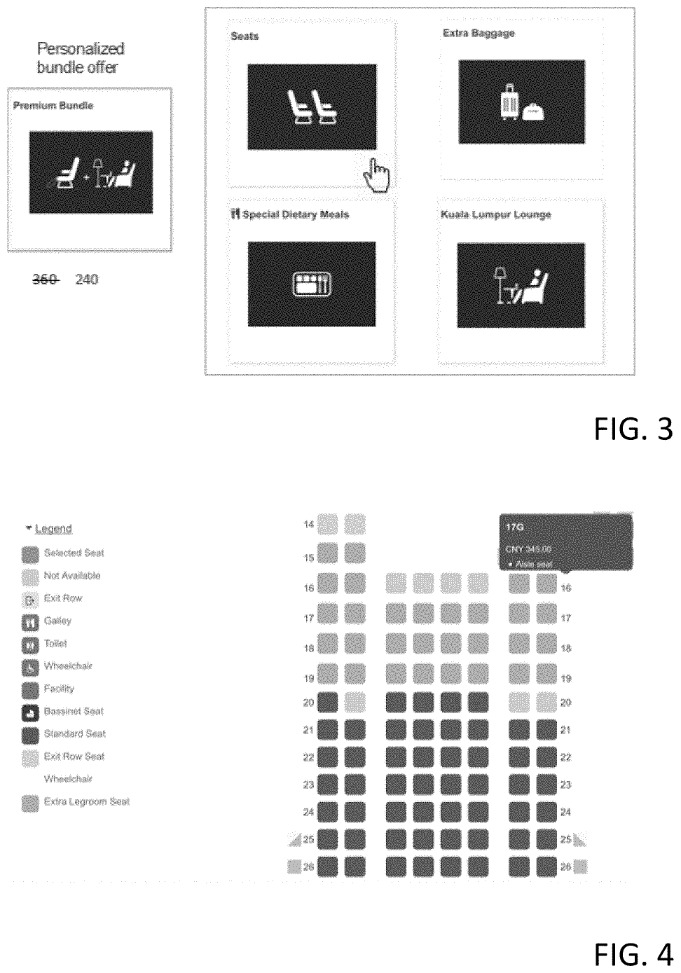

In order to better illustrate the operations of the bundler 144, reference is now made to FIG. 3-4 depicting an example wherein the bundler 144 collects consumer data and transactional data from a travel agency. The consumer data may include demographic information, frequent flier status, and historical travel information such as frequency, recency and revenue of past trips, while the transactional data may include flight data (e.g., seats, prices, times, departing/destination city, availability, etc.), hotel data (e.g., rooms, rates, amenities, availability, etc.), and rental car data (e.g., available makes and models, prices, etc.).

The bundler 144 may model consumer choice in order to identify a relevant bundle (step 204). In embodiments, the bundler 144 may generate one or more models to model consumer choice, and may generate the models using machine learning, e.g., unsupervised learning, based on the collected consumer data and transactional data. The one or more algorithmic models may detail a correlation between the bundling of one or more products and/or services with one or more consumers/consumer groups. The bundler 144 may train the models based on the collected data by identifying and weighting one or more features indicative of a particular consumer's interest in a particular purchased bundle, bundle category, and/or bundle item. The bundler 144 may then apply the trained models to consumer data in real time to predict bundles of interest to a user.

In such models, the bundler 144 may assume that there are K categories of products and/or services in total and each category k may have Nₖ separate products and/or services. Each product or service kjₖ induces a utility for a customer denoted as Uₖⱼ_{ₖ}. Given p(kjₖ) as the price of a product/service, the surplus s(kjₖ) is the difference between the utility and price, denoted by EQ. 1 as:

S(kjₖ)=Uₖⱼ_{ₖ}+ϵₖⱼ_{ₖ}−p(kjₖ) EQ. 1

Where ϵₖⱼ_{ₖ} is noise.

In each category, it is assumed a consumer chooses at most one product/service, and includes a no-purchase option in the case a consumer does not make a purchase. It is assumed that a customer chooses the product which maximizes the surplus. Thus, within each category k, the probability P of choosing a product/service (including no-purchase option) kjₖ may be denoted by EQ. 2 as:

$$P ( s ( {kj}_{k} ) \geq {max}_{1 \leq j \leq {N}_{k}} s ( kj ) ) = P ( {U}_{{kj}_{k}} + {ϵ}_{{kj}_{k}} - p ( {kj}_{k} ) \geq {max}_{j ∈ [ {N}_{k} ]} {u}_{kj} + {ϵ}_{kj} - p ( kj ) ) \qquad EQ . 2$$

Hence, the probably of choosing a particular bundle (j₁, j₂, . . . , j_{K}) is denoted by EQ. 3 as:

$$P ( {⋂}_{k = 1}^{K} ( {U}_{{kj}_{k}} + {ϵ}_{{kj}_{k}} - p ( {kj}_{k} ) \geq {max}_{j ∈ [ {N}_{k} ]} {u}_{kj} + {ϵ}_{kj} - p ( kj ) ) ) = {\sum }_{l = 1}^{L} {μ}_{1} {\prod }_{k = 1}^{K} \frac{{e}^{{β}_{k} {u}_{{kj}_{k}}^{l} - {β}_{k} p ( {kj}_{k} )}}{{\sum }_{j = 0}^{{N}_{k}} {e}^{{β}_{k} {u}_{{kj}_{k}}^{l} - {β}_{k} p ( {kj}_{k} )}} \qquad EQ . 3$$

where μ₁ can be viewed as a customer type and βₖ∈ᵢ are i.i.d. (independent and identically distributed) Gumbel random variables.

Several parameters may need to be estimated. In embodiments, the bundler 144 may estimate the parameters using a mixed multinomial logit model (MMLM). For ease of notation, we use θ to denote the parameters which are needed to be estimated, as shown in EQ. 4 as:

θ=((uₖⱼ_{ₖ}^{l})_{k=1, . . . ,K,j}_{ₖ}_{=1, . . . ,N}_{ₖ}^{l=1, . . . ,L},(βₖ^{l})_{k=1, . . . ,K}^{l=1, . . . ,L},(μₗ)^{t=1, . . . ,L}) EQ. 4

Suppose ω is denoted by EQ. 5 as:

ω=(β₁μ₁₀,β₁μ₁₁, . . . ,β₁μ_{1N}_{₁}, . . . ,β_{K}μ_{KN}_{_{K}},−β₁, . . . ,−β_{K}) EQ. 5

Assume zₖⱼ^{t} is a feature of product j in category k, denoted by EQ. 6 as:

zₖⱼ^{t}=(0,0, . . . ,1,0, . . . 0,p^{t}(kj),0, . . . ,0) EQ. 6

Given ω, the probability of choosing (j₁, j₂, . . . , j_{K}) can be written as EQ 7:

$${f}_{( {j}_{1} , … , {j}_{K} )}^{t} ( ω ) = {\prod }_{k = 1}^{K} \frac{( {ω}^{T} {z}_{{kj}_{k}}^{t} )}{{\sum }_{l ∈ [ {N}_{k} ]} exp ( {ω}^{T} {z}_{{kj}_{k}}^{t} )} = {\prod }_{k = 1}^{K} {h}_{jk}^{t} ( ω ) \qquad EQ . 7$$

Hence, the joint (expected) probability of the choice (j₁, j₂, . . . , jₖ) may be denoted by EQ. 8 as we integrate overall customer types:

g₍ⱼ_{₁}_{,j}_{₂}_{, . . . ,j}_{_{K}}₎^{t}(μ)=∫f₍ⱼ_{₁}_{, . . . j}_{_{K}}₎^{t}(ω)dμ(ω) EQ. 8

The negative log-likelihood (NLL) loss of the joint (expected) probability of the choice j₁, j₂, . . . , jₖ) above may be denoted by EQ. 9 as:

$$NLL ( g ( μ ) ; Data ) = - \frac{1}{N} {\sum }_{t = 1}^{T} {\sum }_{( {j}_{1} , {j}_{2} , … , {j}_{K} )} {N}_{( {j}_{1} , … , {j}_{K} )} log ( {g}_{( {j}_{1} , … , {j}_{K} )}^{t} ( μ ) ) \qquad EQ . 9$$

The optimization problem for minimizing the negative log-likelihood loss above may be denoted by EQ. 10 as:

$${min}_{Q ∈ ϱ} loss ( g ( Q ) ; Data ) \qquad EQ . 10$$

Several algorithms may be utilized to solve the optimization problem of EQ. 10. In embodiments, the bundler 144 may implement nonparametric estimation of mixing distributions. The support finding step may be denoted by EQ. 11 as:

$${f}^{( k )} = arg {min}_{v ∈ \overline{P}} < ∇ loss ( {g}^{k - 1 )} , v - {g}^{( k - 1 )} > \qquad EQ . 11$$

Where P={f(ω):ω∈ [symbol] ^{D}×1}. The algorithm may be a standard Broyden-Fletcher-Goldfarb-Shanno (BFGS) or a more computationally efficient stochastic gradient descent (SGD).

The proportion update step may be denoted by EQ. 12 as:

$${∝}^{( k )} ∈ arg {min}_{∝ ∈ {Δ}^{k}} loss ( {∝}_{0} {g}^{( 0 )} + {\sum }_{s = 1}^{k} {∝}_{s} {f}^{( s )} ) \qquad EQ . 12$$

The output may be mixture proportions ∝₀^{(k)}, ∝₁^{(k)}, . . . , ∝ₖ^{(k)} and customer types g⁽⁰⁾, f⁽¹⁾, . . . , f^{(k)}.

Returning to the illustrative example introduced above and with reference to FIG. 3-4, the bundler 144 may identify latent segments of consumer groups and preferences thereof. A first segment of consumers may prefer bundle X including a first class seat, a five-star hotel, and a luxury rental car. A second segment of consumers may prefer bundle Y which includes a coach seat, four-star hotel, and modest rental car.

The bundler 144 may determine bundle pricing (step 206). Surplus of bundle B (under additive assumption) may be denoted by EQ. 13 as:

s(B)=Σₖ₌₁^{K}s(kj_{K})=Σₖ₌₁^{K}u(kjₖ)+∈(kjₖ)−p(kjₖ) EQ. 13

The probability of choosing bundle B may be denoted by EQ. 14 as:

$$P ( B ) = P ( s ( B ) \geq {max}_{( {j}_{1} , … , {j}_{K} )} {\sum }_{k = 1}^{K} s ( {kj}_{k} ) ) \qquad EQ . 14$$

And expected revenue may be denoted by EQ. 15 as:

p(B)P(B)+Σ₍ⱼ_{₁}_{, . . . ,j}_{_{K}}₎p(j₁, . . . ,j_{K})(Σₖ₌₁^{K}P(jₖ)) EQ. 15

If the estimation is not accurate, the bundler 144 may implement robust optimization using EQ. 16:

$$\begin{matrix}sup & inf \\ p & θ ∈ ▪\end{matrix} Ψ ( p , θ ) \qquad EQ . 16$$

The bundler 144 may further implement distributionally robust optimization (e.g., model misspecification). For a two product example, the formulation is shown in EQ. 17. Note that the expected revenue refers to the revenue generated by the bundle (AB) as well as by the individual products.

$$\begin{matrix}sup & inf \\ p & μ ∈ ℳ ( p )\end{matrix} {E}_{μ} [ Ψ ( p , ξ ) ] {max}_{p} {min}_{w ∈ ℳ} {P}_{w} ( A ) p ( A ) + {P}_{w} ( B ) p ( B ) + {P}_{w} ( AB ) p ( AB ) \qquad EQ . 17$$

Continuing the previously introduced example, the bundler 144 may determine prices for the bundled offers (e.g., while maximizing the joint expected revenue from the bundles (e.g., bundle X and Y) and the individual products (e.g., first class seat, a five-star hotel, coach seat, etc.).

The bundler 144 may display one or more bundled offers to the consumer (step 208). In embodiments, the bundler 144 may display the bundled offers to a consumer via the bundling client 122. The bundled offer may include one or more products and/or one or more services as well as a discounted price of the bundle offers compared to purchasing individual products without the bundle offer. The bundle offers may further include a description of the products and services, multimedia such as photos and videos, relevant links, reviews, etc. The bundled offer may further include an option to accept the bundled offer, reject the bundled offer, and in some embodiments modify the bundled offer by adding or removing individual products, which all may be performed by a consumer using the user interface of the bundling client 144.

With reference to the previously introduced example and FIG. 3-4, the bundler 144 displays the details and cost of bundle X that includes a first class seat, a five-star hotel, and a luxury rental car. In embodiments, the bundler 144 may further display the details and cost of bundle Y that includes a coach seat, four-star hotel, and modest rental car.

The bundler 144 may receive a response to the one or more bundle offers (step 210). In embodiments, the received response may be responsive to the consumer option to accept, reject, or modify the bundle offers, and may be received via the bundling client 122 and the network 108.

Furthering the above example illustrated by FIG. 3-4, the bundler 144 receives a response accepting bundle X. Alternatively, the bundler 144 may receive a response modifying the offer, e.g., selecting a rental car with a large amount of cargo room rather than the luxury car.

The bundler 144 may use reinforcement learning to modify the models for identifying user preference and/or bundle price (step 212). In embodiments, the bundler 144 may utilize the accepting, rejecting, or modification of an offer as an indication of the relevancy of bundles offered to the consumer. For example, the bundler 144 may treat acceptance of a bundle offer as an indication that the bundler 144 is providing bundle offers that are relevant to the consumer while rejection or modification of an offered bundle may be an indication that the model is inaccurate. In response to the received feedback, the bundler 144 may adjust segmentation of the users as well as features and/or weights thereof. When the next customer comes, the bundler 144 may use the updated knowledge and recommend new bundles with updated prices.

Concluding the aforementioned example, the bundler 144 modifies the consumer preference and pricing models in response to the received feedback.

FIG. 3-4 depict an example illustrating the operations of the bundler 144 of the bundling system 100, in accordance with the exemplary embodiments.

FIG. 5 depicts a block diagram of devices used within the bundling system 100 of FIG. 1, in accordance with the exemplary embodiments. It should be appreciated that FIG. 5 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 40 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfilment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and bundle processing 96.

The exemplary embodiments may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for customized bundling of products and services, the method comprising:
gathering data corresponding to one or more consumers, one or more products, and one or more services;
generating one or more bundles of the one or more products and services corresponding to a consumer of the one or more consumers based on applying one or more models to the gathered data;
determining a price of the one or more bundles; and
displaying the one or more bundles to the consumer.

2. The method of claim 1, wherein the displayed one or more bundles each include the one or more products and services of the bundle, a price of the bundle, and a savings of the bundle compared to a price of the bundled products and services purchased individually.

3. The method of claim 1, further comprising:
receiving a response from the consumer to the displayed one or more bundles; and
adjusting the one or more models based on the response.

4. The method of claim 1, wherein the one or more models correlate the one or more products and services with the one or more consumers.

5. The method of claim 1, wherein the one or more products and one or more services each correspond to a category, and wherein the one or more models capture intra-category substitution of the one or more products and one or more services within each category.

6. The method of claim 1, wherein the one or more products and one or more services each correspond to a category, and wherein the one or more models capture cross-category dependence on one another.

7. The method of claim 1, wherein the one or more models are distribution-free.

8. A computer program product for customized bundling of products and services, the computer program product comprising:
one or more non-transitory computer-readable storage media and program instructions stored on the one or more non-transitory computer-readable storage media capable of performing a method, the method comprising:
gathering data corresponding to one or more consumers, one or more products, and one or more services;
generating one or more bundles of the one or more products and services corresponding to a consumer of the one or more consumers based on applying one or more models to the gathered data;
determining a price of the one or more bundles; and
displaying the one or more bundles to the consumer.

9. The computer program product of claim 8, wherein the displayed one or more bundles each include the one or more products and services of the bundle, a price of the bundle, and a savings of the bundle compared to a price of the bundled products and services purchased individually.

10. The computer program product of claim 8, further comprising:
receiving a response from the consumer to the displayed one or more bundles; and
adjusting the one or more models based on the response.

11. The computer program product of claim 8, wherein the one or more models correlate the one or more products and services with the one or more consumers.

12. The computer program product of claim 8, wherein the one or more products and one or more services each correspond to a category, and wherein the one or more models capture intra-category substitution of the one or more products and one or more services within each category.

13. The computer program product of claim 8, wherein the one or more products and one or more services each correspond to a category, and wherein the one or more models capture cross-category dependence on one another.

14. The computer program product of claim 8, wherein the one or more models are distribution-free.

15. A computer system for customized bundling of products and services, the system comprising:
one or more computer processors, one or more computer-readable storage media, and program instructions stored on the one or more of the computer-readable storage media for execution by at least one of the one or more processors capable of performing a method, the method comprising:
gathering data corresponding to one or more consumers, one or more products, and one or more services;
generating one or more bundles of the one or more products and services corresponding to a consumer of the one or more consumers based on applying one or more models to the gathered data;
determining a price of the one or more bundles; and
displaying the one or more bundles to the consumer.

16. The computer system of claim 15, wherein the displayed one or more bundles each include the one or more products and services of the bundle, a price of the bundle, and a savings of the bundle compared to a price of the bundled products and services purchased individually.

17. The computer system of claim 15, further comprising:
receiving a response from the consumer to the displayed one or more bundles; and
adjusting the one or more models based on the response.

18. The computer system of claim 15, wherein the one or more models correlate the one or more products and services with the one or more consumers.

19. The computer system of claim 15, wherein the one or more products and one or more services each correspond to a category, and wherein the one or more models capture intra-category substitution of the one or more products and one or more services within each category.

20. The computer system of claim 15, wherein the one or more products and one or more services each correspond to a category, and wherein the one or more models capture cross-category dependence on one another.
